(19) United States
(12) Patent Application Publication
(10) Pub. No.: US 2003/0051619 A1
(43) Pub. Date: Mar. 20, 2003

(54) Ink chamber for rotary printing machines with face-sided sealing lips, which are at an oblique angle to the axis of rotation of the inking roller

(76) Inventor: Guenter Rogge, Lienen (DE)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/207,018

(22) Filed: Jul. 30, 2002

(30) Foreign Application Priority Data
Sep. 14, 2001 (DE) 101 45 534.8

(51) Int. Cl. B41F 31/00

(52) U.S. Cl. 101/350.6

(57) ABSTRACT

Presented is an ink chamber (1) for rotary printing machines and a process for sealing ink chambers (1),

wherein the ink chambers are formed by at least the following elements:

an inking roller (2), which rotates in operation about an axis (D),

an elongated ink chamber rear wall (4), which defines the ink chamber (1) on at least the side, facing away from the ink roller (2),

two doctor blades (5), which can engage in the shape of a wedge with the inking roller, and two sealing bodies (7, 22), which define the face sides of the ink chamber (1), where the sealing lips (8, 21) of the sealing bodies engage with the inking roller (2).

In so doing, at least one part of the sealing lips (8, 21) runs at an oblique angle in relation to the rotational axis (D) of the inking roller (2).

The invention relates to an ink chamber for rotary printing machines, according to the preamble of claim 1, a sealing body for such an ink chamber and a process for sealing the ink chamber.

Ink chambers for rotary printing machines exist. The EP 0 812 687 A2 shows such an ink chamber, which falls under the preamble of claim 1.

In the said ink chambers, which are used primarily in flexographic printing, the ink losses occur on the face-sided seals. These ink losses incur expense and cleaning work.

Therefore, the object of the present invention is to propose an ink chamber with less loss of ink.

The problem is solved by means of the characterizing part of claim 1.

Other advantageous designs and embodiments of the invention follow from the other claims, the description of the subject matter and the drawings.

The individual figures are as follows.

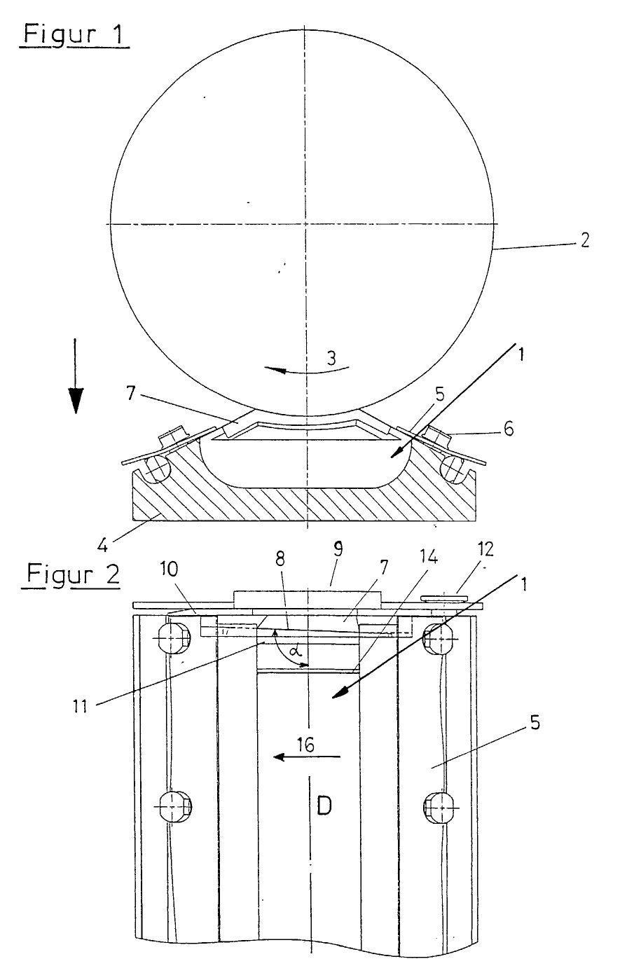

FIG. 1 is a sectional view of an ink chamber.

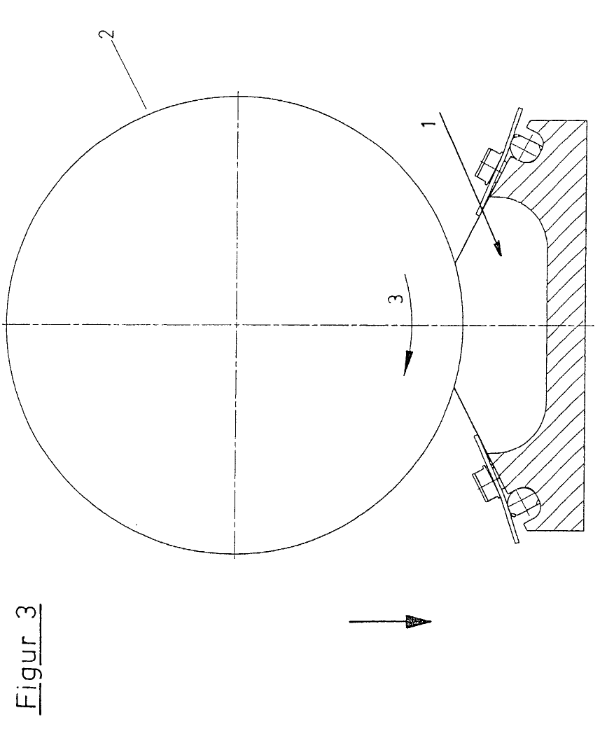

FIG. 2 is a top view of an ink chamber, from which the inking roller is removed.

FIG. 3 is a sectional view of an ink chamber.

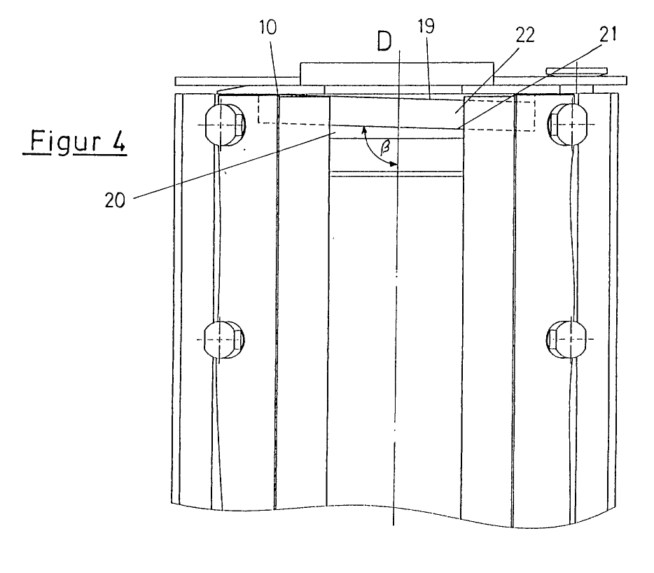

FIG. 4 is a top view of an ink chamber, from which the inking roller is removed.

FIG. 5 depicts the face of a sealing body, which faces in operation the interior of the blade chamber.

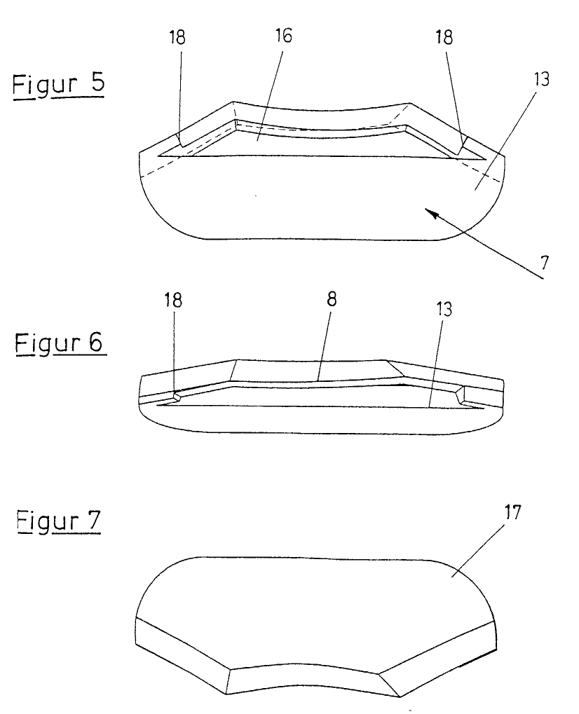

FIG. 6 is a top view of a sealing lip of a sealing body.

FIG. 7 depicts the face of a sealing body, which faces in operation the exterior of the blade chamber.

FIG. 1 is a sectional view of an ink chamber 1, which is defined by the inking roller 2, which rotates in operation in the direction of the arrow 3; an ink chamber rear wall 4; and the doctor blades 5, which can be employed in the shape of a wedge at the inking roller. The doctor blades are fastened to the rear wall of the ink chamber with special fastening elements 6 and can engage with the ink roller. The sealing element 7 assumes the face-sided sealing of the chamber. Ink chambers of this type are used primarily in flexographic printing. However, ink chambers can also be assembled in a modified form. Thus, for example, asymmetrically constructed ink chambers exist.

FIG. 2 is a top view of an ink chamber 1, where the inking roller 2 was removed from the ink chamber so that the view penetrates into the interior of the blade chamber.

Thus, of the aforementioned limiting elements the two doctor blades 5 and the ink chamber rear wall can be seen.

The sealing element 7 is fastened between the barrier plate 11 and the intermediate plate. The intermediate plate is forced in turn by the clamping plate 9 against the sealing element 7 and the ink chamber rear wall 4.

The fastening element 12 serves, among other things, this purpose. To hold the ink chamber as tight as possible, said chamber 1 has in the illustrated example (according to FIG. 2) a barrier, which is made of sheet metal or plastic and is in front of the seal. Through insertion of this barrier, the ink, which is vorticized by the motion of the inking roller 2, is already decelerated before it comes into contact with the seal 7.

In the embodiment shown in FIG. 2, the seal 7 is installed in such a manner that its face 13, which faces the interior of the ink chamber, runs orthogonally to the axis of motion of the roller 2.

The roller's direction of motion is indicated by the straight arrow 16. However, the sealing lip 8 of the seal 7 runs at an angle greater than 0 degrees with respect to the face 14. Thus, at least the part of the sealing lip between the two edges 18 runs at an angle alpha relative to the axis of rotation of the roller that differs from 90 degrees. In this respect acute angles are preferred.

A seal of this type is also shown in FIGS. 5 to 7. FIG. 5 depicts the side 13 of the seal 7 that faces the ink chamber in the installed state. The seal 7 has a recess 16, which improves the elasticity of the sealing lip 8. FIG. 6 is another view of the seal 7, which discloses, in which way a part of the sealing lip 8 between the two edges 18 is sloped in relation to the face 13.

FIG. 7 depicts the face 17 of the seal 7 facing away from the ink chamber.

FIGS. 3 and 4 depict another embodiment of the invention. FIG. 3 is a sectional view of an inventive device, which is largely equivalent to that depicted in FIG. 1. Only the face-sided limiting elements of the ink chamber 1 (for example, the barrier plate 11 and the seal 7) were not depicted.

FIG. 4, like FIG. 2, is a top view of an ink chamber 1, where the inking roller 2 was moved away from the ink chamber so that the view penetrates into the interior of the blade chamber.

However, at variance with the embodiment of FIG. 2, in this embodiment of the invention the entire seal 22 is installed at a different angle than 90 degrees in relation to the axis of rotation D of the roller motion. The goal was achieved in this embodiment in that wedge-shaped spacers 19, 20 were inserted between seal 7 and barrier plate 11 or between seal and clamping plate 9. The sealing lip 8 of the seal used is identical to the edge that faces the roller 2 and belongs to the inside face 13 of the seal 7. Since the entire seal 7 is at a different angle than 90 degrees to the axis of rotation D of the roller movement, the entire length of the sealing lip in this embodiment is at a different angle beta than 90 degrees. In the embodiment depicted in FIG. 2, it is the case only with that part of the sealing lip 8 that is located between the two edges 18 of the sealing lip (see FIG. 6).

List of Reference Numerals and Characters

| | |
|---|---|
| 1 | ink chamber |
| 2 | inking roller |
| 3 | curved arrow in the roller's direction of motion |
| 4 | ink chamber rear wall |
| 5 | doctor blade |
| 6 | fastening elements of the doctor blades |
| 7 | seal/sealing element |
| 8 | sealing lip |
| 9 | clamping plate |
| 10 | intermediate plate |
| 11 | barrier plate |
| 12 | fastening element |
| 13 | the face facing the ink chamber |
| 14 | barrier |
| 15 | straight arrow in the direction of the roller motion |
| 16 | recess |
| 17 | face facing away from the ink chamber |
| 18 | edges of the sealing lip |
| 19 | wedge-shaped spacers |
| 20 | wedge-shaped spacers |
| 21 | sealing lip |
| 22 | seal/sealing element |
| 23 | |
| 24 | |
| 25 | |
| alpha | angle between the rotational axis of the roller and sealing lip |
| | (FIG. 2) |
| beta | angle between the rotational axis of the roller and sealing lip |
| | (FIG. 4) |
| D | axis of roller motion |

1. Ink chamber (1) for rotary printing machines, which is formed by at least the following elements:
an inking roller (2), which rotates in operation about an axis (D),
an elongated ink chamber rear wall (4), which defines the ink chamber (1) on at least the side, facing away from the ink roller (2),
two doctor blades (5), which can engage in the shape of a wedge with the inking roller, and two sealing bodies (7, 22), which define the face sides of the ink chamber (1), wherein the sealing lips (8, 21) of the sealing bodies engage with the inking roller (2),
characterized in that
at least one part of the sealing lips (8, 21) runs at an oblique angle in relation to the rotational axis (D) of the inking roller (2).

2. Ink chamber (1), as claimed in claim 1,
characterized in that
the sealing lips (8) of the sealing bodies (7) are sloped in the direction of the face (13, 17) of the sealing bodies.

3. Ink chamber, as claimed in claim 1,
characterized in that
the entire sealing body (22) is at an oblique angle in relation to the rotational axis of the inking roller.

4. Sealing body (7) for sealing an ink chamber (1), as claimed in claim 1,
characterized in that
the sealing lips (8) of the sealing bodies (7) are sloped in the direction of the face (13) of the sealing bodies.

5. Process for sealing an ink chamber (1), as claimed in the preamble of claim 1,
characterized in that
the sealing lips (8, 21) are at an oblique angle (alpha, beta) in relation to the rotational axis (D) of the inking roller (1).
